(19) United States
(12) Patent Application Publication
(10) Pub. No.: US 2012/0288278 A1
(43) Pub. Date: Nov. 15, 2012

(54) PASSIVE OPTICAL SPLITTER AND PASSIVE OPTICAL NETWORK SYSTEM

(75) Inventors: Cong Chen, Shenzhen (CN); Xiaoping Zhou, Shenzhen (CN); Jun Zhao, Shenzhen (CN); Weiyang Wang, Shenzhen (CN)

(73) Assignee: Huawei Technologies Co., Ltd., Shenzhen (CN)

(21) Appl. No.: 13/458,391

(22) Filed: Apr. 27, 2012

Related U.S. Application Data
(63) Continuation of application No. PCT/CN2011/073813, filed on May 9, 2011.

(51) Int. Cl. H04J 14/02; H04B 10/20; G02B 6/26

(52) U.S. Cl. 398/58; 385/43

(57) ABSTRACT

The present invention provides a passive optical splitter and a passive optical network system. The passive optical splitter includes at least two splitting single-mode waveguides, at least one combining single-mode waveguide, and at least one tapered waveguide, where one end of the tapered waveguide is coupled to the at least two splitting single-mode waveguides respectively, the other end of the tapered waveguide is coupled to the at least one combining single-mode waveguide, and a core layer of the tapered waveguide is made of a light-induced refractive index changeable material. When an optical signal is transmitted, light transmission is limited by increasing a refractive index difference between positions with different optical field intensity in the core layer, thus reducing a loss of optical signal leakage and improving uplink transmission efficiency.

### CROSS-REFERENCE TO RELATED APPLICATION

This application is a continuation of International Application No. PCT/CN2011/073813, filed on May 9, 2011, which is hereby incorporated by reference in its entirety.

### FIELD OF THE INVENTION

Embodiments of the present invention relate to optical communication technologies, and in particular, to a passive optical splitter (Passive Optical Splitter, referred to as POS) and a passive optical network system (Passive Optical Network, referred to as PON).

### BACKGROUND OF THE INVENTION

With an increasing demand of a user for a network bandwidth, a conventional copper wire broadband access network is confronted with a bandwidth bottleneck, and an optical access network becomes a strong competitor among next generation broadband access networks. Among various optical access networks, a passive optical network (Passive Optical Network, referred to as PON) system is most competitive.

FIG. 1 is a schematic structural diagram of an existing PON system. As shown in FIG. 1, the existing PON system includes an optical line terminal (Optical Line Terminal, referred to as OLT) that is located at a central office, at least one passive optical splitter (Passive Optical Splitter, referred to as POS), and at least one optical network unit (Optical Network Unit, referred to as ONU) that is located at a user end. A direction from an OLT to an ONU is a downlink direction, and in the downlink direction, a POS is configured to split downlink signal power from the OLT into a plurality of signals and send the signals to at least one ONU respectively; and a direction from the ONU to the OLT is an uplink direction, and in the uplink direction, the POS adopts a time division multiplexing mode to enable at least one uplink signal from at least one ONU to pass in sequence and sends the uplink signal to the OLT.

Existing types of POSs include a fused biconical taper (Fused Biconical Taper, referred to as FBT) type and a planar lightwave circuit (Planar Lightwave Circuit, referred to as PLC) type. Taking a 1:2 POS as an example, in the downlink direction, the POS splits optical power into two branches, where a loss of each branch is 50%, that is, 3 dB. In the uplink direction, 50% of light input from one of the branches is leaked, and only 50% can pass, that is, a loss is also 3 dB. Taking a 1:32 POS with a commercial PLC-type as an example, a loss in the uplink direction and a loss in the downlink direction are both about 17 dB according to actual measurement, thus causing that 96% of light is leaked, and in this way, the ONU needs to have higher power in order to penetrate the POS and perform signal transmission. Therefore, in the uplink direction, a large amount of light is leaked during transmission in an existing POS, thus causing a serious optical loss problem, so that uplink transmission efficiency is quite low.

### SUMMARY OF THE INVENTION

Embodiments of the present invention provide a POS and a PON to solve an optical loss problem in the prior art, where the optical loss problem is caused by light leakage of a passive optical splitter in an uplink direction, so as to reduce a optical loss during uplink transmission, thus improving uplink transmission efficiency.

An embodiment of the present invention provides a POS, including at least two splitting single-mode waveguides, at least one combining single-mode waveguide, and at least one tapered waveguide, where one end of the tapered waveguide is coupled to the at least two splitting single-mode waveguides, and the other end of the tapered waveguide is coupled to the at least one combining single-mode waveguide; and a core layer of the tapered waveguide is made of a light-induced refractive index changeable material, and a nonlinear refractive index coefficient of the light-induced refractive index changeable material is higher than a refractive index coefficient of silicon dioxide.

An embodiment of the present invention further provides a PON, including an optical line terminal OLT, a first wavelength division multiplexer WDM, a first passive optical splitter POS, at least one second WDM, and at least one optical network unit ONU; where

each ONU is connected to one second WDM, and transfers an uplink optical signal to a corresponding second WDM;

one side of each second WDM is connected to one ONU and the other side is connected to the first POS, and each second WDM transfers an uplink optical signal from a corresponding ONU to the first POS;

the first POS includes at least two splitting single-mode waveguides, at least one combining single-mode waveguide, and at least one tapered waveguide, where one end of the tapered waveguide is coupled to the at least two splitting single-mode waveguides, the other end of the tapered waveguide is coupled to the at least one combining single-mode waveguide, and a core layer of the tapered waveguide is made of a light-induced refractive index changeable material; a nonlinear refractive index coefficient of the light-induced refractive index changeable material is higher than a refractive index coefficient of silicon dioxide; and each splitting single-mode waveguide is connected to one second WDM, and receives an uplink optical signal from the second WDM, and the combining single-mode waveguide is connected to the first WDM, and transfers the uplink optical signal from the second WDM to the first WDM; and

one side of the first WDM is connected to the first POS and the other side is connected to the OLT, and the first WDM transfers an uplink optical signal from the first POS to the OLT.

It can be known from the preceding technical solutions that, in the embodiments of the present invention, the core layer of the tapered waveguide of the POS is fabricated by adopting the light-induced refractive index changeable material, so that when an optical signal is transmitted, the optical signal causes that a refractive index of the core layer changes according to optical field distribution, where the refractive index changes greatly at a position with high optical field intensity, and the refractive index changes slightly at a position with low optical field intensity, therefore, light transmission can be limited, thus reducing a leakage loss of an optical signal during uplink transmission and improving uplink transmission efficiency.

### BRIEF DESCRIPTION OF THE DRAWINGS

To describe the technical solutions in the embodiments of the present invention or in the prior art more clearly, the accompanying drawings required for describing the embodiments or the prior art are introduced briefly in the following. Apparently, the accompanying drawings in the following description are merely some embodiments of the present invention, and persons of ordinary skill in the art may also obtain other drawings according to these accompanying drawings without creative efforts.

FIG. 1 is a schematic structural diagram of an existing PON system;

FIG. 2A is a top view of a schematic structural diagram of a POS according to a first embodiment of the present invention;

FIG. 2B is a left view of the schematic structural diagram of the POS according to the first embodiment of the present invention;

FIG. 2C is an instance of the schematic structural diagram of the POS according to the first embodiment of the present invention;

FIG. 3 is a schematic diagram showing a relation between output efficiency of the POS and change of a refractive index of a core layer of the POS according to the first embodiment of the present invention;

FIG. 4 is a schematic structural diagram of a PON system according to a second embodiment of the present invention; and

FIG. 5 is a schematic structural diagram of a PON system according to a third embodiment of the present invention.

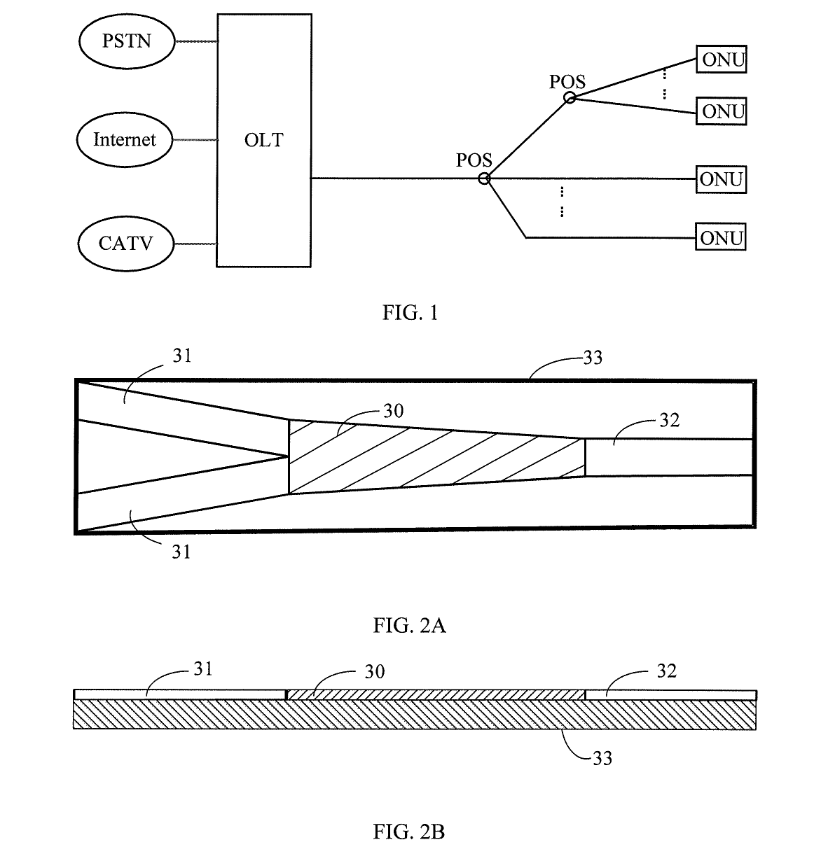

### DETAILED DESCRIPTION OF THE EMBODIMENTS

The technical solutions in the embodiments of the present invention are clearly and fully described in the following with reference to the accompanying drawings in the embodiments of the present invention. Apparently, the embodiments to be described are only a part rather than all of the embodiments of the present invention. Based on the embodiments of the present invention, all other embodiments obtained by persons of ordinary skill in the art without creative efforts shall fall within the protection scope of the present invention.

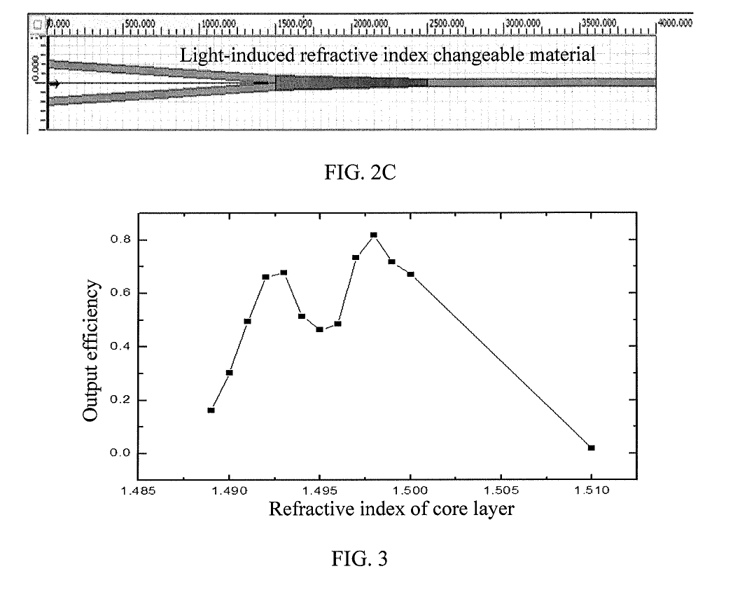

FIG. 2A is a top view of a schematic structural diagram of a POS according to a first embodiment of the present invention. FIG. 2B is a left view of the schematic structural diagram of the POS according to the first embodiment of the present invention. Taking FIG. 2A as an example, as shown in FIG. 2A, the POS may be a low-loss passive optical splitter (Low-loss Passive Optical Splitter, referred to as LPOS), and a structure of the POS includes at least two splitting single-mode waveguides 31, at least one combining single-mode waveguide 32, and at least one tapered waveguide 30. One end of the tapered waveguide 30 is coupled to the at least two splitting single-mode waveguides 31, the other end is coupled to the at least one combining single-mode waveguide 32, and the POS is disposed on a silicon substrate 33. A core layer of the tapered waveguide 30 is made of a light-induced refractive index changeable material. The light-induced refractive index changeable material is a nonlinear material, and when light passes through the material, a refractive index of the material changes. A nonlinear refractive index coefficient of the light-induced refractive index changeable material is higher than a refractive index coefficient of silicon dioxide, and generally, the nonlinear refractive index coefficient of the light-induced refractive index changeable material is 100000 times the refractive index coefficient of the silicon dioxide. Preferably, the light-induced refractive index changeable material may adopt a third-order nonlinear material, such as AsₓS_{y}, Ge₂₅Se₇₅₋ₓ or TeO₂, but is not limited to the preceding three kinds of materials. A length of the tapered waveguide 30 may be set according to an actual requirement, and may also be different with different selected materials, and for example, a length range of the tapered waveguide 30 may be set to be 1500 nm to 2500 nm. A width of the tapered waveguide 30 is also correlated to a specific material of a selected light-induced refractive index changeable material, and for general single-mode transmission, a dimension of the tapered waveguide 30 may be determined according to a refractive index difference between the core layer of the tapered waveguide 30 and a cladding layer (or a lower cladding layer) of the tapered waveguide 30, where a specific instance of the schematic structural diagram is shown in FIG. 2C.

Based on the preceding technical solution, not only the tapered waveguide 30 may adopt the light-induced refractive index changeable material, but any one of the splitting single-mode waveguide 31 and the combining single-mode waveguide 32 may also adopt the light-induced refractive index changeable material. That is, any one of the following cases may exist: A core layer of the splitting single-mode waveguide 31 and the core layer of the tapered waveguide 30 are made of the light-induced refractive index changeable material; a core layer of the combining single-mode waveguide 32 and the core layer of the tapered waveguide 30 are made of the light-induced refractive index changeable material; and the core layer of the splitting single-mode waveguide 31, the core layer of the combining single-mode waveguide 32, and the core layer of the tapered waveguide 30 are all made of the light-induced refractive index changeable material.

Specifically, the POS in the first embodiment of the present invention has a Y branch type, and includes the following parts: at least two splitting single-mode waveguides 31, a combining single-mode waveguide 32, and a tapered waveguide 30. For a core layer of the splitting single-mode waveguide 31, a core layer of the combining single-mode waveguide 32, and a core layer of the tapered waveguide 30, in the POS in the first embodiment of the present invention, at least the core layer of the tapered waveguide 30 adopts a light-induced refractive index changeable material, and the core layer of the splitting single-mode waveguide 31 and the core layer of the combining single-mode waveguide 32 may also adopt a light-induced refractive index changeable material. The light-induced refractive index changeable material is a nonlinear material. Preferably, the light-induced refractive index changeable material may adopt a third-order nonlinear material, such as AsₓS_{y}, Ge₂₅Se₇₅₋ₓ, or TeO₂, but is not limited to the preceding three kinds of materials.

In an optical network system, the POS in the first embodiment of the present invention may replace an existing POS, and not only may be used as a POS for uplink transmission, but may also be used as a POS for downlink transmission.

A method for manufacturing the POS in the first embodiment of the present invention is described briefly in the following. According to an existing waveguide fabrication process, the POS is described by taking a specific implementation manner in which the core layer of the splitting single-mode waveguide 31, the core layer of the combining single-mode waveguide 32, and the core layer of the tapered waveguide 30 all adopt the light-induced refractive index changeable material as an example. The POS manufacturing method is: manufacturing at least two splitting single-mode waveguides, a combining single-mode waveguide, and a tapered waveguide, where core layers of the at least two splitting single-mode waveguides, a core layer of the combining single-mode waveguide, and a core layer of the tapered waveguide are made of a light-induced refractive index changeable material, and one end of the tapered waveguide is coupled to the at least two splitting single-mode waveguides and the other end is coupled to the combining single-mode waveguide. The light-induced refractive index changeable material may adopt AsₓS_{y}, Ge₂₅Se₇₅₋ₓ, or TeO₂, that is, the core layer of the splitting waveguide, the core layer of the combining waveguide and the core layer of the tapered waveguide of the POS may be manufactured by adopting the preceding materials, which are not limited to the preceding materials. Specifically, the POS manufacturing method may include the following steps.

Step 1: Fabricate a silicon dioxide layer on a silicon wafer.

In this step, specifically, a silicon dioxide layer may be fabricated on a silicon wafer by adopting a plasma enhanced chemical vapor deposition (Plasma Enhanced Chemical Vapor Deposition, referred to as PECVD) method or a flame hydrolysis deposition (Flame Hydrolysis Deposition, referred to as FHD) method.

Step 2: Deposit a film of the light-induced refractive index changeable material on a lower cladding layer of the silicon dioxide layer by adopting an ultra-fast pulsed laser deposition (Ultra-fast Pulsed Laser Deposition, referred to as UFPLD) method.

In this step, specifically, by taking the use of As₂S₃ as the light-induced refractive index changeable material as an example, a As₂S₃ film is deposited on the lower cladding layer of the silicon dioxide layer by adopting UFPLD.

Step 3: After spin coating a photoresist on the film of the light-induced refractive index changeable material, perform exposure processing by using a mask plate.

In this step, a light-shielding chromium film with the same structure as that of a POS waveguide is fabricated on the mask plate in advance, that is, a structure of the light-shielding chromium film is the same as a structure obtained by coupling the at least two splitting single-mode waveguides, the combining single-mode waveguide, and the tapered waveguide. Specifically, a BP212 photoresist is taken as an example. First, a layer of the photoresist is spin coated on the As₂S₃ film, and then the mask plate is pressed on a surface of the photoresist and a photoetching machine is used for exposure, so as to expose the photoresist.

Step 4: Perform development processing on the exposed photoresist.

In this step, specifically, still taking the BP212 photoresist as an example, an exposed photoresist film is placed in a 1:50 NaOH developer for development.

Step 5: Perform etching processing on a developed film of the light-induced refractive index changeable material.

In this step, specifically, still taking the use of As₂S₃ as the light-induced refractive index changeable material as an example, an As₂S₃ film exposed after development is etched by using an inductive coupled plasma emission spectrometer (Inductive Coupled Plasma Emission Spectrometer, referred to as ICP) etching machine, where an etching gas may be a gas mixture of CF₄ and O₂.

Step 6: Spin coat an upper cladding layer on an etched film of the light-induced refractive index changeable material.

In this step, specifically, still taking the use of As₂S₃ as the light-induced refractive index changeable material as an example, polysiloxane is spin coated on an etched As₂S₃ film to serve as a cladding layer, thus completing fabrication of the POS waveguide.

Furthermore, to facilitate fusion splicing of the POS in an optical system, on an optical platform, an optical fiber array disposed in a V-shaped slot may also be coupled to and aligned with the splitting single-mode waveguide and the combining single-mode waveguide of the POS respectively, and then the splitting single-mode waveguide and the combining single-mode waveguide of the POS are adhered by using ultraviolet glue.

By adopting the preceding method, a POS, in which the core layer of the splitting single-mode waveguide 31, the core layer of the combining single-mode waveguide 32, and the core layer of the tapered waveguide 30 all adopt the light-induced refractive index changeable material, may be manufactured.

In the POS in the first embodiment of the present invention, at least the core layer of the tapered waveguide 30 adopts the light-induced refractive index changeable material, and the core layer of the splitting single-mode waveguide 31 and the core layer of the combining single-mode waveguide 32 may also adopt the light-induced refractive index changeable material. According to a material characteristic of the light-induced refractive index changeable material, when light passes through the material, a refractive index of the material increases with optical intensity, where a refractive index of a medium changes greatly at a position with high optical intensity, and the refractive index of the medium changes slightly at a position with low optical intensity, so that a refractive index difference between positions with different optical field intensity in the core layer increases. Since an optical field has a characteristic of being preferentially transmitted in a medium with a high refractive index, the higher the optical field intensity is, the higher the refractive index is, and the more likely the optical field is concentrated and transmitted at this position, so that a loss caused by radiation of the optical field toward the outside of the tapered waveguide 30 is reduced by increasing the refractive index difference between positions with different optical field intensity in the core layer to limit light transmission, thus enhancing output optical intensity during uplink transmission, so that an optical loss during uplink transmission is reduced, and output efficiency of the POS is improved. That is, when being triggered by an optical signal, the POS that adopts the light-induced refractive index changeable material to fabricate the core layer enters a low-loss state.

FIG. 3 is a schematic diagram showing a relation between output efficiency of the POS and change of a refractive index of a core layer of the POS according to the first embodiment of the present invention. The core layer adopts a light-induced refractive index changeable material, and the output efficiency is output efficiency when the POS is used as a POS for uplink transmission, that is, output efficiency obtained when a splitting single-mode waveguide 31 is used as an input end and a combining single-mode waveguide 32 is used as an output end. As shown in FIG. 3, an abscissa represents a refractive index of the core layer in an optical field intensity distribution region, and an ordinate represents the output efficiency of the POS. When no light passes through the POS, the refractive index of the core layer does not change, and at this time, the refractive index of the core layer is 1.495, and the output efficiency of the POS is 0.46, that is, 46%. When light passes through the POS, the refractive index of the core layer changes due to influence of an optical field, and after the change, the refractive index of the core layer is 1.498, and the output efficiency of the POS is 0.82, that is, 82%. Uplink output efficiency of the POS in the first embodiment of the present invention is 82%, that is, a loss is 18%, and compared with an uplink loss, 50%, of an existing POS, the POS in the first embodiment of the present invention significantly reduces an optical loss caused by optical signal leakage, thus improving uplink transmission efficiency.

In the first embodiment of the present invention, the core layer of the tapered waveguide of the POS is fabricated by adopting the light-induced refractive index changeable material, so that when an optical signal is transmitted, the optical signal causes that the refractive index of the core layer in the optical field distribution region changes, where the higher optical intensity at a position is, the higher the refractive index is, so that a loss of optical signal leakage is reduced by increasing a refractive index difference between positions with different optical field intensity in the core layer to limit light transmission, thus enhancing optical intensity of an output optical signal during uplink transmission, and improving uplink transmission efficiency. Furthermore, the POS is a real passive device, which may be disposed at any position in a PON network, and is applied flexibly and conveniently.

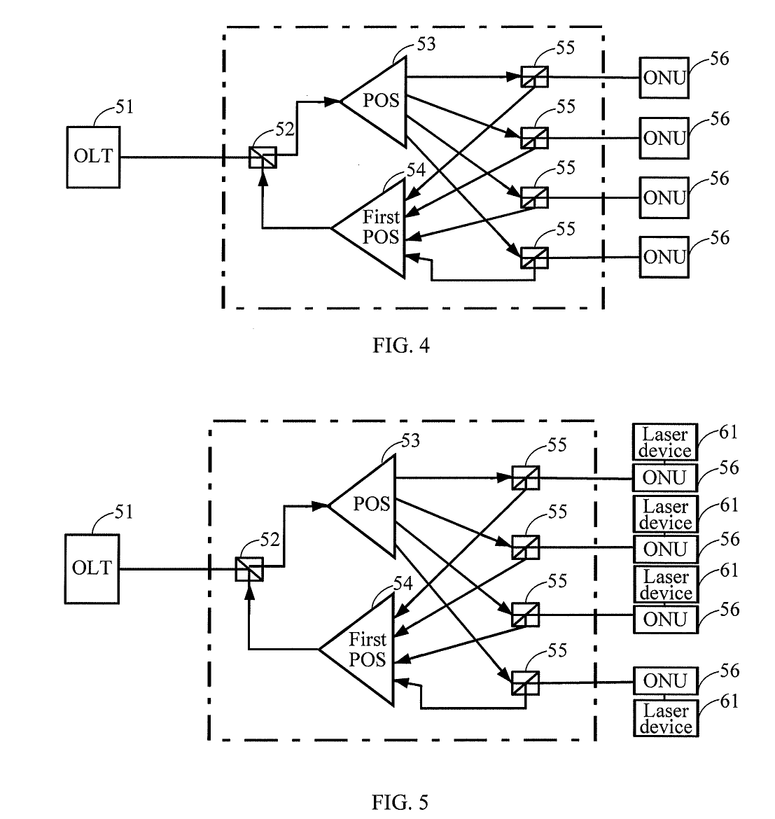

FIG. 4 is a schematic structural diagram of a PON system according to a second embodiment of the present invention. The POS described in the first embodiment of the present invention is adopted in the PON system. As shown in FIG. 4, the PON system at least includes: an OLT 51, a first WDM 52, a first POS 54, at least one second WDM 55, and at least one ONU 56.

In an uplink direction, each ONU 56 is connected to one second WDM 55, and each ONU 56 generates an uplink signal and transfers the uplink signal to a corresponding second WDM 55. One side of each second WDM 55 is connected to one ONU 56 and the other side is connected to the first POS 54, and each second WDM 55 transfers an uplink optical signal from a corresponding ONU 56 to the first POS 54. The first POS 54 enables at least one uplink optical signal from the at least one second WDM 55 to pass in sequence according to time division multiplexing, and transfers the at least uplink optical signal to the first WDM 52. One side of the first WDM 52 is connected to the first POS 54 and the other side is connected to the OLT 51, and the first WDM 52 transfers an uplink optical signal from the first POS 54 to the OLT 51.

The first POS 54 in the PON system adopts the POS described in the first embodiment of the present invention. Specifically, the first POS 54 includes at least two splitting single-mode waveguides, at least one combining single-mode waveguide, and at least one tapered waveguide, where one end of the tapered waveguide is coupled to the at least two splitting single-mode waveguides respectively, and the other end is coupled to the at least one combining single-mode waveguide. When the first POS 54 is connected to the first WDM 52 and the second WDM 55 respectively, the splitting single-mode waveguide and the combining single-mode waveguide are encapsulated with a single-mode optical fiber array by using ultraviolet glue, each splitting single-mode waveguide is coupled to one second WDM 55, and receives an uplink optical signal from the second WDM 55, and the combining single-mode waveguide is connected to the first WDM 52, and transfers the uplink optical signal from the second WDM 55 to the first WDM 52.

In the first POS 54, at least a core layer of the tapered waveguide is made of a light-induced refractive index changeable material. Or, based on that the core layer of the tapered waveguide is made of the light-induced refractive index changeable material, one of a core layer of the splitting single-mode waveguide and a core layer of the combining single-mode waveguide or both core layers of the two are also made of a light-induced refractive index changeable material. Preferably, the light-induced refractive index changeable material may adopt a third-order nonlinear material, such as AsₓS_{y}, Ge₂₅Se₇₅₋ₓ or TeO₂, but is not limited to the preceding three kinds of materials. When an uplink optical signal is transmitted in the PON system, the optical signal causes that a refractive index of the core layer in an optical field distribution region changes, where the higher optical intensity at a position is, the larger a refractive index difference is, so that light transmission is limited, and a loss of optical signal leakage is reduced, thus enhancing optical intensity of an output optical signal during uplink transmission, and improving uplink transmission efficiency.

Based on the preceding technical solution, furthermore, the PON system may further include a POS 53. The POS 53 may adopt an existing POS in any form, and is configured for downlink transmission.

Specifically, the OLT 51 transfers a downlink optical signal to the first WDM 52. One side of the first WDM 52 is connected to the OLT 51 and the other side is connected to the POS 53 and the first POS 54, and the first WDM 52 is configured to perform wave division multiplexing on a combining uplink optical signal and a combining downlink optical signal. One side of the POS 53 is connected to the first WDM 52 and the other side is connected to the at least one second WDM 55. One side of each second WDM 55 is connected to the POS 53 and the first POS 54 and the other side of the second WDM 55 is connected to one ONU 56, and the second WDM 55 is configured to perform wave division multiplexing on a splitting uplink optical signal and a splitting downlink optical signal of the ONU 56 that is connected to the POS 53.

In a downlink direction, the OLT 51 transfers the downlink optical signal to the first WDM 52, and the first WDM 52 transfers the downlink optical signal from the OLT 51 to the POS 53. The POS 53 splits and transfers the downlink optical signal from the first WDM 52 to the at least one second WDM 55. Specifically, the POS 53 splits the downlink optical signal from the first WDM 52 to obtain at least one split downlink optical signal, and transfers each split downlink optical signal to one second WDM 55. Each second WDM 55 transfers a downlink optical signal obtained by itself from the POS 53 to a connected ONU 56.

In other embodiments of the present invention, the LPOS described in the first embodiment of the present invention may also be adopted to replace the POS 53. That is, the PON system not only includes an OLT 51, a first WDM 52, a first POS 54, at least one second WDM 55, and at least one ONU 56, but also includes a second POS. A connection relation of the second POS in the PON system is the same as that of the POS 53. Specifically, the second POS includes at least two splitting single-mode waveguides, a combining single-mode waveguide, and at least one tapered waveguide. One end of the tapered waveguide is coupled to the at least two splitting single-mode waveguides, the other end is coupled to the at least one combining single-mode waveguide, and a core layer of the tapered waveguide is made of a light-induced refractive index changeable material. The combining single-mode waveguide is connected to the first WDM 52 and receives a downlink optical signal from the first WDM 52, and each splitting single-mode waveguide is connected to one second WDM 55 and transfers the downlink optical signal from the first WDM 52 to a corresponding second WDM 55.

In the second POS, at least the core layer of the tapered waveguide is made of the light-induced refractive index changeable material. Or, based on that the core layer of the tapered waveguide is made of the light-induced refractive index changeable material, one of a core layer of the splitting single-mode waveguide and a core layer of the combining single-mode waveguide or both core layers of the two are also made of the light-induced refractive index changeable material. Preferably, the light-induced refractive index changeable material may adopt a third-order nonlinear material, such as AsₓS_{y}, Ge₂₅Se₇₅₋ₓ, or TeO₂, but is not limited to the preceding three kinds of materials (a specific description of a length, a width, and a refractive index range of the light-induced refractive index changeable material is consistent with that in the first embodiment, and reference may be made to the description in the first embodiment for details, which is not described here again).

In the second embodiment of the present invention, in the first POS for uplink transmission in the PON system, the core layer of the tapered waveguide is fabricated by adopting the light-induced refractive index changeable material. When an uplink optical signal is transmitted, the uplink optical signal itself triggers the first POS to enter a low-loss state, and causes that the refractive index of the core layer in the optical field distribution region changes, where the higher optical intensity at a position is, the larger the refractive index difference is, so that light transmission is limited, thus enhancing optical intensity of an output optical signal during uplink transmission. Therefore, by using the PON system in the second embodiment of the present invention, a loss of optical signal leakage during uplink transmission can be reduced, and uplink transmission efficiency is improved.

FIG. 5 is a schematic structural diagram of a PON system according to a third embodiment of the present invention. In the technical solution in the first embodiment of the present invention, the core layer of the tapered waveguide of the POS may be fabricated by adopting multiple kinds of specific light-induced refractive index changeable materials. In actual application, different materials have different characteristics, for example, response time of some light-induced refractive index changeable materials is longer, and response power of some light-induced refractive index changeable materials is higher, and in view of the preceding two cases, a PON system provided in the third embodiment of the present invention may be adopted.

A structure of the PON system in the third embodiment of the present invention not only includes the PON system described in the second embodiment of the present invention, but also includes at least one laser device 61, where each ONU 56 is connected to one laser device 61. As shown in FIG. 5 the PON system includes an OLT 51, a first WDM 52, a POS 53, a first POS 54, at least one second WDM 55, at least one ONU 56, and at least one laser device 61.

Herein, a structure and connection relation of the OLT 51, the first WDM 52, the POS 53, the first POS 54, the at least one second WDM 55, and the at least one ONU 56 are the same as those of the PON system described in the second embodiment of the present invention, which are not described here again. The first POS 54 in the PON system adopts the POS described in the first embodiment of the present invention. Specifically, the first POS 54 includes at least two splitting single-mode waveguides, at least one combining single-mode waveguide, and at least one tapered waveguide. At least a core layer of the tapered waveguide is made of a light-induced refractive index changeable material. Or, based on that the core layer of the tapered waveguide is made of the light-induced refractive index changeable material, one of a core layer of the splitting single-mode waveguide and a core layer of the combining single-mode waveguide or both core layers of the two are also made of a light-induced refractive index changeable material. Preferably, the light-induced refractive index changeable material may adopt a third-order nonlinear material, such as AsₓS_{y}, Ge₂₅Se₇₅₋ₓ or TeO₂, but is not limited to the preceding three kinds of materials. Because the core layer of the tapered waveguide is made of the light-induced refractive index changeable material, when an optical signal asses through the material, the optical signal causes that a refractive index of the core layer in an optical field distribution region changes, where the higher optical intensity at a position is, the larger a refractive index difference is, so that light transmission is limited, and a loss of optical signal leakage is reduced, thus enhancing optical intensity of an output optical signal during uplink transmission, and improving uplink transmission efficiency.

For the at least one laser device 61, each laser device 61 is connected to one ONU 56, and is configured to send a pilot laser before the ONU 56 that is connected to the laser device 61 sends an uplink optical signal. The pilot laser is sent before the ONU 56 uploads a splitting uplink optical signal, and is used for triggering refractive index change in the first POS 54. The pilot laser may be controlled by the ONU 56 to be embedded into a signal code of the splitting uplink optical signal. Specifically, the pilot laser is sent at a position of a signal head of an uplink optical signal that is to be uploaded, and because a core layer of the first POS 54 adopts the light-induced refractive index changeable material, the pilot laser enters the tapered waveguide of the first POS 54 and causes that a refractive index of the core layer of the tapered waveguide changes, so that light transmission is limited, and a leakage loss during uplink transmission of the first POS 54 is reduced. In this way, when an uplink optical signal following the pilot laser reaches the first POS 54, a low-loss mode of the first POS 54 for the uplink optical signal has already been turned on, so that the uplink optical signal may pass through the first POS 54 in a low-loss manner. Preferably, because a high-power laser or a narrow-pulse laser achieves a nonlinear effect more easily, the laser device 61 may adopt a high-power laser device 61 or a narrow-pulse laser device 61.

In the third embodiment of the present invention, in the first POS for uplink transmission in the PON system, not only the core layer of the tapered waveguide is fabricated by adopting the light-induced refractive index changeable material, but also a laser device is configured for each ONU. Before the ONU sends an uplink optical signal, the laser device sends a pilot laser, and the pilot laser is used for triggering the first POS to enter a low-loss state, so that a refractive index of the light-induced refractive index changeable material in the first POS changes, so as to reduce a leakage loss of the first POS. When a formal uplink optical signal is transmitted, the uplink optical signal can directly pass through the first POS in a low-loss manner, thus further reducing the loss of optical signal leakage during uplink transmission, and improving the uplink transmission efficiency.

It should be noted that, to facilitate the description, the preceding method embodiments are expressed as a series of operations; however, it should be known by persons skilled in the art that the present invention is not limited to a sequence of the described operations, because some steps may be performed in other sequences or concurrently according to the present invention. Furthermore, it should also be known by persons skilled in the art that all the embodiments described in the specification are exemplary embodiments, and involved operations and modules may not be necessary for the present invention.

In the preceding embodiments, a focus of the description of each embodiment is different, and for a part that is not detailed in an embodiment, reference may be made to the relevant descriptions in other embodiments.

Persons of ordinary skill in the art may understand that all or a part of the steps of the preceding method embodiments may be implemented by a program instructing relevant hardware. The program may be stored in a computer readable storage medium. When the program runs, the steps of the preceding method embodiments are performed. The storage medium may be any medium that is capable of storing program codes, such as a ROM, a RAM, a magnetic disk, or a compact disk.

Finally, it should be noted that the preceding embodiments are merely used for describing the technical solutions of the present invention, but are not intended to limit the present invention. It should be understood by persons of ordinary skill in the art that although the present invention has been described in detail with reference to the preceding embodiments, modifications may still be made to the technical solution described in each preceding embodiment, or equivalent replacements may be made to part of technical features in the technical solutions, however, these modifications or replacements do not make the essence of the corresponding technical solution depart from the spirit and scope of the technical solution in each embodiment of the present invention.

1. A passive optical splitter POS, comprising: at least two splitting single-mode waveguides, at least one combining single-mode waveguide, and at least one tapered waveguide, wherein one end of the tapered waveguide is coupled to the at least two splitting single-mode waveguides, and the other end of the tapered waveguide is coupled to the at least one combining single-mode waveguide; and a core layer of the tapered waveguide is made of a light-induced refractive index changeable material, wherein a nonlinear refractive index coefficient of the light-induced refractive index changeable material is higher than a refractive index coefficient of silicon dioxide.

2. The POS according to claim 1, wherein the light-induced refractive index changeable material comprises a third-order nonlinear material.

3. The POS according to claim 1, wherein the light-induced refractive index changeable material comprises one of AsxSy, Ge25Se75-x, or TeO2.

4. The POS according to claim 1, wherein
a core layer of the splitting single-mode waveguide is made of a light-induced refractive index changeable material.

5. The POS according to claim 1, wherein
a core layer of the combining single-mode waveguide is made of a light-induced refractive index changeable material.

6. A passive optical network system PON, comprising: an optical line terminal OLT, a first wavelength division multiplexer WDM, a first passive optical splitter POS, at least one second WDM, and at least one optical network unit ONU; wherein
each ONU is connected to one second WDM, and transfers an uplink optical signal to a corresponding second WDM;
one side of each second WDM is connected to one ONU and the other side is connected to the first POS, and transfers an uplink optical signal from the corresponding ONU to the first POS;
the first POS comprises at least two splitting single-mode waveguides, at least one combining single-mode waveguide, and at least one tapered waveguide, wherein one end of the tapered waveguide is coupled to the at least two splitting single-mode waveguides, the other end of the tapered waveguide is coupled to the at least one combining single-mode waveguide, and a core layer of the tapered waveguide is made of a light-induced refractive index changeable material; a nonlinear refractive index coefficient of the light-induced refractive index changeable material is higher than a refractive index coefficient of silicon dioxide; and each splitting single-mode waveguide is connected to one second WDM, and receives an uplink optical signal from the second WDM, and the combining single-mode waveguide is connected to the first WDM, and transfers the uplink optical signal from the second WDM to the first WDM; and
one side of the first WDM is connected to the first POS and the other side is connected to the OLT, and the first WDM transfers an uplink optical signal from the first POS to the OLT.

7. The system according to claim 6, further comprising: a passive optical splitter POS; wherein
the OLT further transfers a downlink optical signal to the first WDM;
the first WDM is further connected to the POS, and transfers the downlink optical signal from the OLT to the POS;
one side of the POS is connected to the first WDM and the other side is connected to the at least one second WDM, and the POS splits and transfers the downlink optical signal from the first WDM to the at least one second WDM; and
each second WDM is further connected to the POS, and transfers the downlink optical signal from the POS to a corresponding ONU.

8. The system according to claim 6, further comprising: a second POS; wherein
the OLT further transfers a downlink optical signal to the first WDM;
the first WDM is further connected to the second POS, and transfers the downlink optical signal from the OLT to the second POS;
the second POS comprises at least two splitting single-mode waveguides, at least one combining single-mode waveguide, and at least one tapered waveguide, wherein one end of the tapered waveguide is coupled to the at least two splitting single-mode waveguides respectively, the other end of the tapered waveguide is coupled to the at least one combining single-mode waveguide, and a core layer of the tapered waveguide is made of a light-induced refractive index changeable material; the combining single-mode waveguide is connected to the first WDM and receives a downlink optical signal from the first WDM; and each splitting single-mode waveguide is connected to one second WDM and transfers the downlink optical signal from the first WDM to a corresponding second WDM; and
each second WDM is further connected to the second POS, and transfers a downlink optical signal from the second POS to a corresponding ONU.

9. The system according to claim 6, wherein the light-induced refractive index changeable material comprises a third-order nonlinear material.

10. The system according to claim 9, wherein the light-induced refractive index changeable material comprises one of AsxSy, Ge25Se75-x, or TeO2.

11. The system according to claim 6, wherein
a core layer of the splitting single-mode waveguide is made of a light-induced refractive index changeable material.

12. The system according to claim 6, wherein
a core layer of the combining single-mode waveguide is made of a light-induced refractive index changeable material.

13. The system according to claim 6, further comprising:
at least one laser device, wherein the laser device is connected to the ONU, and is configured to send a pilot laser before the ONU sends an uplink optical signal.

14. The POS according to claim 2, wherein the light-induced refractive index changeable material comprises one of AsxSy, Ge25Se75-x, or TeO2.

15. The system according to claim 7, wherein the light-induced refractive index changeable material comprises a third-order nonlinear material.

16. The system according to claim 8, wherein the light-induced refractive index changeable material comprises a third-order nonlinear material.

17. The system according to claim 9, wherein the light-induced refractive index changeable material comprises one of AsxSy, Ge25Se75-x, or TeO2.

18. The system according to claim 15, wherein the light-induced refractive index changeable material comprises one of AsxSy, Ge25Se75-x, or TeO2.

19. The system according to claim 16, wherein the light-induced refractive index changeable material comprises one of AsxSy, Ge25Se75-x, or TeO2.

20. The system according to claim 17, wherein the light-induced refractive index changeable material comprises one of AsxSy, Ge25Se75-x, or TeO2.
